(19) United States
(12) Patent Application Publication
(10) Pub. No.: US 2012/0007918 A1
(43) Pub. Date: Jan. 12, 2012

(54) INKJET RECORDING HEAD, INKJET PRINTER, AND INKJET RECORDING METHOD

(75) Inventors: Kazuhiko Ohtsu, Shizuoka-ken (JP); Atsushi Kubota, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/169,143

(22) Filed: Jun. 27, 2011

Related U.S. Application Data
(60) Provisional application No. 61/362,094, filed on Jul. 7, 2010.

(51) Int. Cl. B41J 2/135; B41J 2/14

(52) U.S. Cl. 347/45; 347/47

(57) ABSTRACT

According to one embodiment, an inkjet recording head includes an orifice member, a first cover member and a second cover member. The orifice member includes an ejection hole which ejects ink. The first cover member includes a peripheral surface, which surrounds the outer peripheral surface of the orifice member, one end face arranged near the orifice member, and an other end and an ink regulating section formed on the peripheral surface and suppresses movement of ink. The second cover member is arranged to extend to the other end of the peripheral surface of the first cover member.

### CROSS-REFERENCE TO RELATED APPLICATIONS

This application is based upon and claims the benefit of priority from: U.S. Provisional Application No. 61/362,094 filed on Jul. 7, 2010, the entire contents of each of which are incorporated herein reference.

### FIELD

Embodiments described herein relate generally to an inkjet recording head, an inkjet printer, and an inkjet recording method.

### BACKGROUND

An example of an inkjet printer includes a sheet conveying drum configured to rotate about a rotation axis. A sheet as a recording medium is held on the circumferential surface of the sheet conveying drum. An inkjet recording head is arranged to be opposed to the circumferential surface of the sheet conveying drum. The inkjet recording head ejects ink to the sheet held on the sheet conveying drum to thereby form an image on the sheet.

An example of the inkjet recording head includes an orifice member including a nozzle row including plural ejection holes, a channel forming member through which ink passes, a first cover member configured to protect the nozzle row of the orifice member, and a second cover member. The first cover member and the second cover member form a cover structure. In the inkjet printer in which the inkjet recording head is arranged to be opposed to the circumferential surface of the sheet conveying drum, the orifice member could be attached to a frame in a state in which the orifice member is obliquely tilted with respect to the horizontal plane. In particular, if plural inkjet recording heads are arranged in the circumferential direction of the sheet conveying drum, several inkjet recording heads are arranged in a posture in which the surfaces of orifice members are tilted with respect to the horizontal plane.

A part of the ink ejected from the ejection holes of the inkjet recording head could remain on the surface of the orifice member. If the orifice member is tilted as explained above, when the ink adhering to the surface of the orifice member increases because of some reason, the ink could creep up along the peripheral surface of the first cover member while wetting the peripheral surface with the surface tension or the like.

### BRIEF DESCRIPTION OF THE DRAWINGS

FIG. 1 is a schematic side view of the inside of an inkjet printer according to a first embodiment;

FIG. 2 is a perspective view of an inkjet recording head of the inkjet printer shown in FIG. 1;

FIG. 3 is a sectional view of the inkjet recording head taken along line F3-F3 in FIG. 2;

FIG. 4 is a schematic side view of the inkjet recording head shown in FIG. 2 and ink droplets;

FIG. 5 is a perspective view of a head maintenance device of the inkjet printer shown in FIG. 1;

FIG. 6 is a perspective view of an inkjet recording head according to a second embodiment;

FIG. 7 is a perspective view of an inkjet recording head according to a third embodiment;

FIG. 8 is a perspective view of an inkjet recording head according to a fourth embodiment;

FIG. 9 is a sectional view of a part of an inkjet recording head according to a fifth embodiment; and

FIG. 10 is a sectional view of a part of an inkjet recording head according to a sixth embodiment.

### DETAILED DESCRIPTION

In general, according to one embodiment, an inkjet recording head comprises an orifice member, a first cover member and a second cover member. The orifice member includes an ejection hole which ejects ink. The first cover member includes a peripheral surface, which surrounds the outer peripheral surface of the orifice member, one end face arranged near the orifice member, and an other end and including an ink regulating section formed on the peripheral surface and suppresses movement of ink. The second cover member arranged to extend to the other end of the peripheral surface of the first cover member.

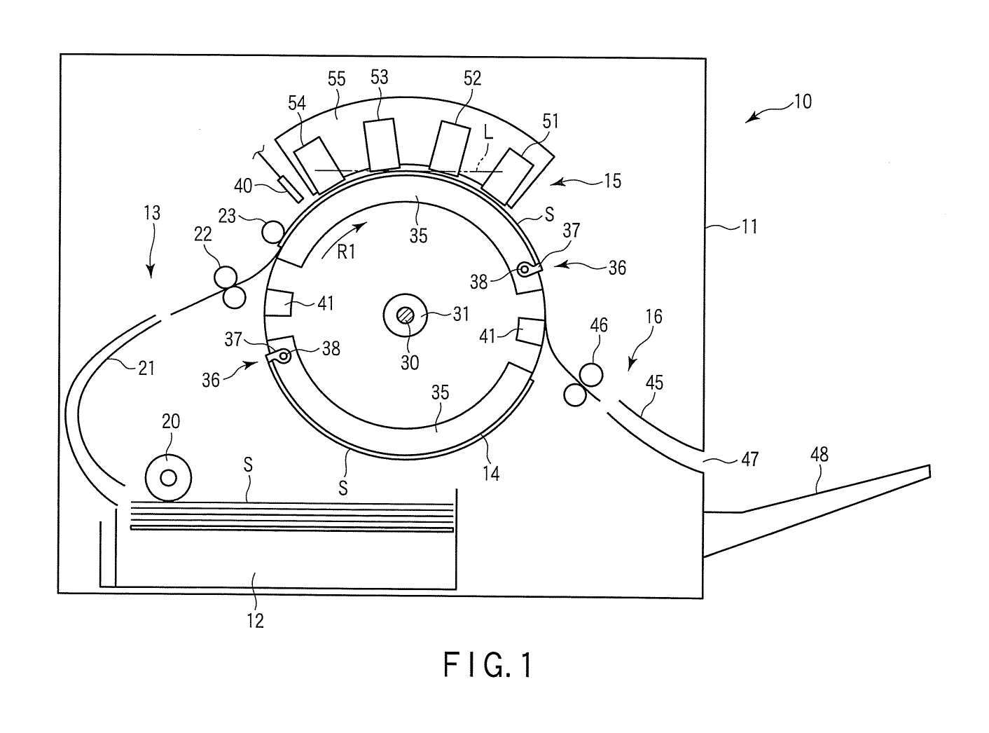

An inkjet printer including an inkjet recording head according to a first embodiment is explained below with reference to FIGS. 1 to 5.

FIG. 1 is a side view of an inkjet printer 10. The inkjet printer 10 includes a housing 11, a sheet storing section 12, a sheet feeding mechanism 13, a sheet conveying drum 14, a recording head section 15, and a sheet discharge mechanism 16. The sheet storing section 12 stores plural sheets S serving as recording media. The sheet feeding mechanism 13 includes a feeding roller 20, a sheet conveying path 21, a gate roller 22, and a pressing roller 23. The sheet conveying drum 14 is housed on the inside of the housing 11 and forms a sheet conveying mechanism for conveying the sheet S to the recording head section 15.

The sheet conveying drum 14 is rotated about an axis 30 by a not-shown rotating mechanism at desired circumferential speed in a direction indicated by an arrow R1. The position in a rotating direction of the sheet conveying drum 14 is detected by an encoder 31. The sheet conveying drum 14 includes an attracting section 35 and a holding mechanism 36 for holding the sheet S. The attracting section 35 is connected to a negative pressure generating mechanism (not shown). The sheet S is attracted to the circumferential surface of the sheet conveying drum 14 by negative pressure generated in the attracting section 35. The holding mechanism 36 includes a pawl member 37 configured to hold the leading end of the sheet S and a shaft member 38, which is the rotation center of the pawl member 37.

A sheet detection sensor 40 is provided between the recording head section 15 and the pressing roller 23. An ink receiving section 41 configured to receive excess ink is arranged in a part in the circumferential direction of the sheet conveying drum 14.

In this embodiment, the sheet S is fixed to the sheet conveying drum 14 by the negative pressure. Instead, the sheet conveying drum may be configured to give charges to a dielectric to thereby fix a sheet with electrostatic attraction force. The sheet discharge mechanism 16 includes a conveyance guide 45, a conveying roller 46, a discharge port 47, and a discharge tray 48.

The recording head section 15 includes plural inkjet recording heads 51, 52, 53, and 54 for color printing. A basic configuration is common to the respective inkjet recording heads 51, 52, 53, and 54. Therefore, the first inkjet recording head 51 is representatively explained below.

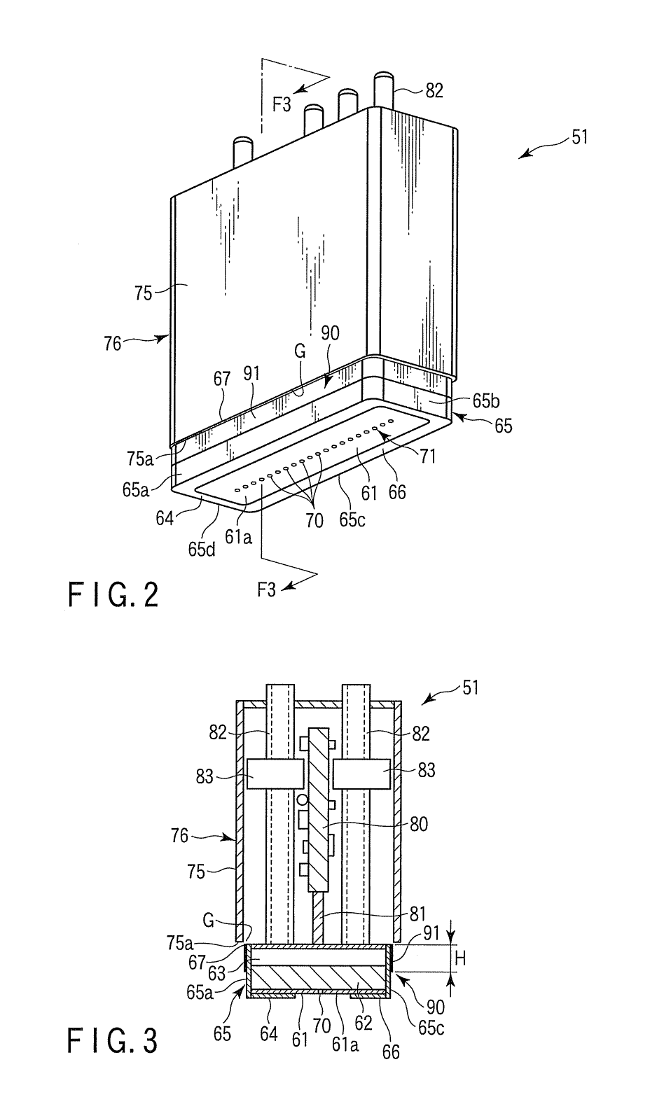

FIG. 2 is a perspective view of the inkjet recording head 51. FIG. 3 is a sectional view of the inkjet recording head 51. The inkjet recording head 51 includes an orifice member 61, a driving member 62, an ink chamber 63, and a first cover member (a mask plate) 64. A nozzle row 71 including plural ejection holes 70 is formed in the orifice member 61. Ink repellent treatment is applied to a surface (an orifice surface) 61a of the orifice member 61 in order to prevent adhesion of ink. The ink repellent treatment prevents a part of ink ejected from the ejection holes 70 from adhering to the surface 61a of the orifice member 61 to close the ejection holes 70. The first cover member 64 is made of, for example, stainless steel having thickness of about 300 μm. The cover member 64 includes a peripheral surface 65 that surrounds the outer periphery of the orifice member 61 and the outer periphery of the driving member 62, an end face (one end face) 66, and a rear end (the other end) 67. The peripheral surface 65 includes at least a first surface 65a, a second surface 65b, a third surface 65c, and a fourth surface 65d. The end face 66 is provided near the orifice member 61. As shown in FIG. 3, the end face 66 and the orifice member 61 are arranged to overlap each other. The nozzle row 71 of the orifice member 61 and the driving member 62 are protected by the first cover member 64.

An example of the driving member 62 is a piezoelectric element deformed according to an applied voltage. By applying voltage to the piezoelectric element, the piezoelectric element is deformed to apply pressure to the ink to thereby eject the ink from the ejection holes 70. The ink chamber 63 communicates with the ejection holes 70. A heat generating element may be adopted as the driving member 62. In that case an inkjet recording head including the heat generating element heats ink with the heat generating element, thus the ink is ejected from ejection holes by pressure of bubbles formed by evaporation of the ink.

The inkjet recording head 51 includes a second cover member (a top cover) 75. The second cover member 75 is arranged to extend to the rear end 67 of the first cover member 64. The first cover member 64 and the second cover member 75 form a cover structure 76. A slight gap G could be present between the rear end 67 of the first cover member 64 and an edge 75a of the second cover member 75.

A circuit board 80 on which circuit components are mounted, a flexible wiring board 81, an ink transfer tube 82, and an ink filter 83 are housed on the inside of the second cover member 75. The ink transfer tube 82 communicates with the ink chamber 63. The circuit board 80 is connected to a not-shown power supply circuit and supplies an electric current for driving the driving member 62 to the driving member 62.

The inkjet recording heads 51, 52, 53, and 54 are attached to a frame 55 (shown in FIG. 1) along the circumferential surface of the sheet conveying drum 14. Therefore, the inkjet recording heads 51, 52, 53, and 54 are arranged in an oblique posture with respect to a horizontal plane L (shown in FIG. 1). Tilts of the inkjet recording heads 51, 52, 53, and 54 are different from one another.

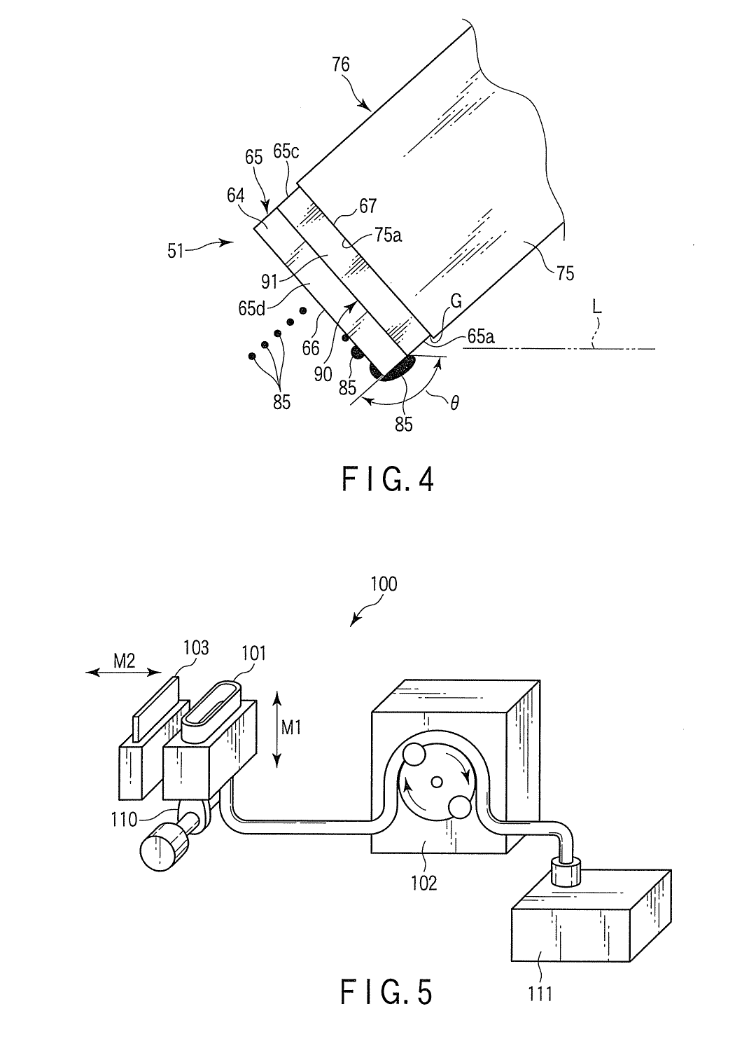

For example, as shown in FIG. 4, the first inkjet recording head 51 is arranged in a posture tilted with respect to the horizontal plane L. In that case, the surface 61a of the orifice member 61 does not face directly downward. In other words, the surface 61a of the orifice member 61 is tilted with respect to the horizontal plane L. A part of ink droplets 85 ejected from the ejection holes 70 of the orifice member 61 could adhere to the surface 61a of the orifice member 61 after the ejection of the ink is stopped. If the ink droplets 85 start to accumulate on the surface 61a of the orifice member 61 because of some cause, a part of the ink droplets 85 could adhere to the end face 66 of the first cover member 64 and creep up on the peripheral surface 65 of the first cover member 64 while wetting the peripheral surface 65. Unless some measures are taken, a part of the ink creeping up on the peripheral surface 65 is likely to enter the inner side of the cover structure 76 from the gap G of the cover structure 76.

Therefore, in the inkjet recording head 51 according to this embodiment, an ink regulating section 90 is provided on the peripheral surface 65 of the first cover member 64. The ink regulating section 90 has a function of suppressing movement of the ink. An example of the ink regulating section 90 is an ink repellent treatment surface 91 formed on the peripheral surface 65 of the first cover member 64. The ink repellent treatment surface 91 is formed over height H (shown in FIG. 3) in an upper part of the entire peripheral surface 65 of the first cover member 64, i.e., a side distant from the orifice member 61. The ink repellent treatment surface 91 according to this embodiment is continuous without being disconnected over four surfaces 65a, 65b, 65c, and 65d that form the peripheral surface 65 of the first cover member 64.

The ink repellent treatment surface 91 is formed by applying, for example, polyfluoroethylene or silicone water repellent resin to the surface of the first cover member 64 of stainless steel or evaporating the water repellent resin. The water replant treatment surface 91 can repel oil-based or water-based ink. A contact angle θ (shown in FIG. 4) of the ink with the ink repellent treatment surface 91 takes a value larger than a contact angle of the ink with a base material of the first cover member 64 such as the stainless steel plate. In the inkjet recording head 51 in which the orifice member 61 is tilted with respect to the horizontal plane L, even if the ink droplets 85 accumulates on the end face 66 of the first cover member 64, the ink droplets 85 is suppressed from rising to the gap G by the ink repellent treatment surface 91.

FIG. 5 is a perspective view of the head maintenance mechanism 100. The head maintenance mechanism 100 removes the ink droplets 85 adhering to the orifice member 61 and the first cover member 64. When cleaning of the inkjet recording head 51 is performed by the head maintenance mechanism 100, the inkjet recording head 51 is moved in a direction away from the sheet conveying drum 14 together with the frame 55.

The head maintenance mechanism 100 includes a cap member 101 that can cover the first cover member 64, an attracting device 102, and a blade member 103. The cap member 101 can be moved in a direction indicated by an arrow M1 in FIG. 5 by a cap driving mechanism 110. The cap member 101 moves between a position where the cap member 101 covers the orifice member 61 and a position where the cap member 101 exposes the orifice member 61.

The blade member 103 is moved in a direction indicated by an arrow M2 by a not-shown driving mechanism to thereby wipe the surface 61a of the orifice member 61 and the end face 66 of the first cover member 64. The ink droplets 85 adhering to the orifice member 61 and the first cover member 64 are attracted by the attracting device 102 and sent to a waste ink tank 111.

An overview of a printing process by the inkjet printer 10 is explained below.

As shown in FIG. 1, the sheet S is conveyed to the attracting section 35 of the sheet conveying drum 14 by the sheet feeding mechanism 13. The leading end of the conveyed sheet S is held by the holding mechanism 36 and the sheet S is attracted by the attracting section 35. In this way, the sheet S is fixed to the circumferential surface of the sheet conveying drum 14. The sheet S attracted to the sheet conveying drum 14 moves in a direction R1, in which the sheet conveying drum 14 rotates, together with the rotating sheet conveying drum 14. The recording head section 15 ejects the ink to the sheet S held on the sheet conveying drum 14 to thereby form an image on the sheet S.

For example, in the case of color printing, when the sheet S held on the sheet conveying drum 14 reaches the first inkjet recording head 51, first ink is ejected from the first inkjet recording head 51 to the sheet S. The sheet S rotates while being kept attracted to the sheet conveying drum 14 and reaches the second inkjet recording head 52. Then, second ink is ejected from the second inkjet recording head 52 to the sheet S. The sheet conveying drum 14 further rotates, whereby third ink is ejected from the third inkjet recording head 53 to the sheet S. The sheet conveying drum 14 further rotates, whereby fourth ink is ejected from the fourth inkjet recording head 54 to the sheet S. While the sheet conveying drum 14 rotates plural times, a color image is formed on the sheet S. In other words, the inkjet printer 10 performs color printing in a line-head type multipath system.

As in this embodiment, it is relatively easy for the inkjet printer 10, in which plural inkjet recording heads 51 to 54 are arranged in the circumferential direction of the sheet conveying drum 14, to accurately regulate positional accuracy of the sheet conveying drum 14 and the inkjet recording heads 51 to 54. Therefore, there is an advantage that the inkjet printer 10 easily forms a high-definition color image, the structure of the inkjet printer 10 is relatively simple, and the inkjet printer 10 can form a high-definition image at high speed.

Moreover, the ink regulating sections 90 having the ink repellent treatment surfaces 91 are provided on the inkjet recording heads 51 to 54. Therefore, the ink droplets 85 adhering to the orifice members 61 of the inkjet recording heads 51 to 54 attached in the posture tilted with respect to the horizontal plane L can be prevented from moving to the gap G of the cover structure 76. In other words, the ink droplets 85 can be prevented from intruding into the inside of the cover structure 76 from the gap G. Therefore, the circuit board 80, the ink filter 83, a bonding section, or the like housed on the inner side of the cover structure 76 is prevented from being stained by the ink. The highly reliable inkjet recording head 51 can be provided.

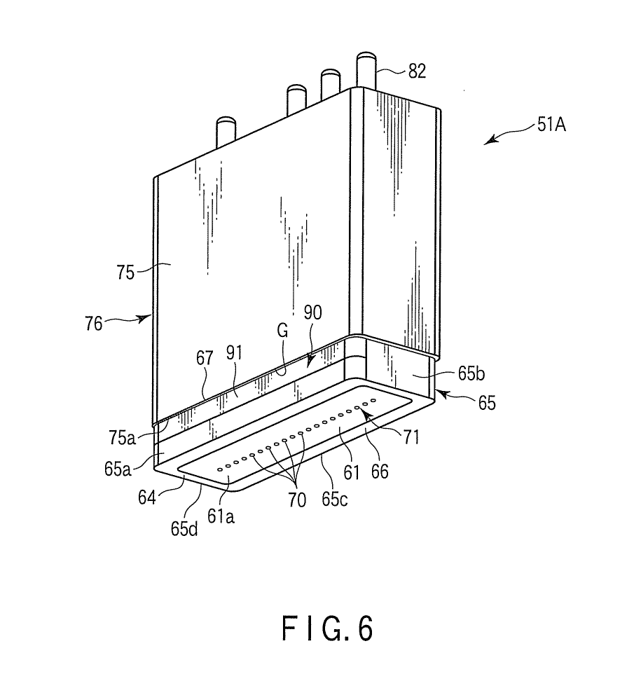

FIG. 6 is a perspective view of an inkjet recording head 51A according to a second embodiment. In the case of this embodiment, the ink repellent treatment surface 91 is formed only on the lower surface 65a in the peripheral surface 65 of the first cover member 64 of the inkjet recording head 51A arranged in a tilted posture. With this configuration, an area of the ink repellent treatment surface 91 only has to be about a half of an area of the ink repellent treatment surface 91 of the inkjet recording head 51 according to the first embodiment. Therefore, cost required for ink repellent treatment can be reduced.

The other components and actions of the inkjet recording head 51A are the same as those of the inkjet recording head 51 according to the first embodiment. Therefore, the same components are denoted by the same reference numerals and signs and explanation of the components is omitted.

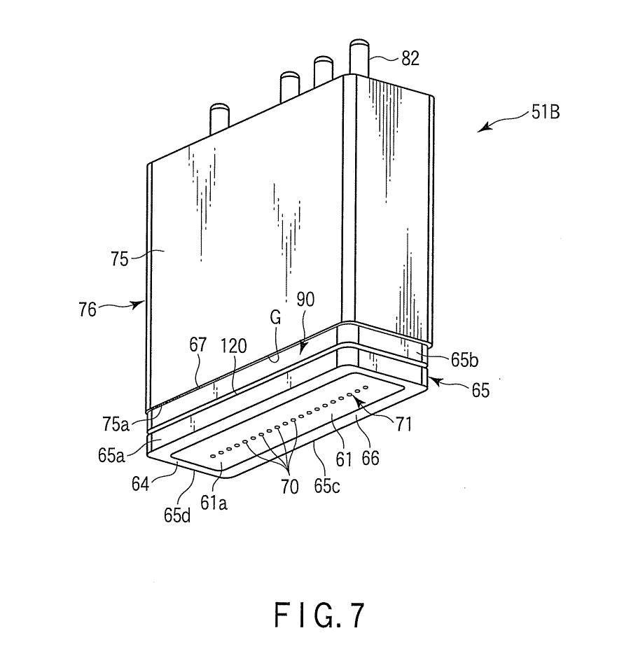

FIG. 7 is a perspective view of an inkjet recording head 51B according to a third embodiment. In the inkjet recording head 51B, a groove 120 is formed on the peripheral surface 65 of the first cover member 64 of synthetic resin as the ink regulating section 90. The groove 120 is continuous over the surfaces 65a, 65b, 65c, and 65d that form the peripheral surface 65 of the first cover member 64. In the inkjet recording head 51B, when ink droplets adhering to the surface 61a of the orifice member 61 move to the gap G of the cover structure 76, the ink droplets enter the groove 120. Therefore, the ink droplets are prevented from reaching the gap G. The groove 120 may be provided only in a part (the surface 65a on the lower side) of the peripheral surface 65 of the first cover member 64. The other components and actions of the inkjet recording head 51B are the same as those of the inkjet recording head 51 according to the first embodiment. Therefore, the same components are denoted by the same reference numerals and signs and explanation of the components is omitted.

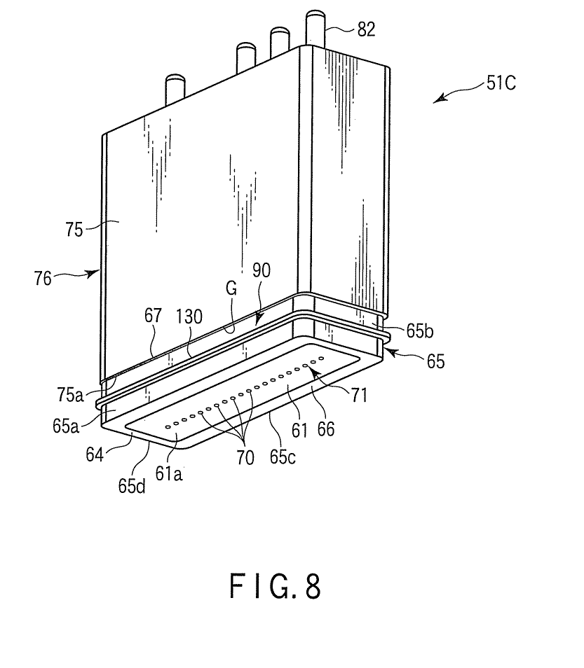

FIG. 8 is a perspective view of an inkjet recording head 51C according to a fourth embodiment. In the inkjet recording head 51C, a ridge 130 is formed on the peripheral surface 65 of the first cover member 64 as the ink regulating section 90. The ridge 130 is continuous over the surfaces 65a, 65b, 65c, and 65d that form the peripheral surface 65 of the first cover member 64. In the inkjet recording head 51C, when ink droplets adhering to the surface 61a of the orifice member 61 move to the gap G of the cover structure 76, the movement of the ink droplets is blocked by the ridge 130. Therefore, the ink droplets are prevented from reaching the gap G. The ridge 130 may be provided in a part (the surface 65a on the lower side) of the peripheral surface 65 of the first cover member 64. The other components and actions of the inkjet recording head 51C are the same as those of the inkjet recording head 51 according to the first embodiment. Therefore, the same components are denoted by the same reference numerals and signs and explanation of the components is omitted.

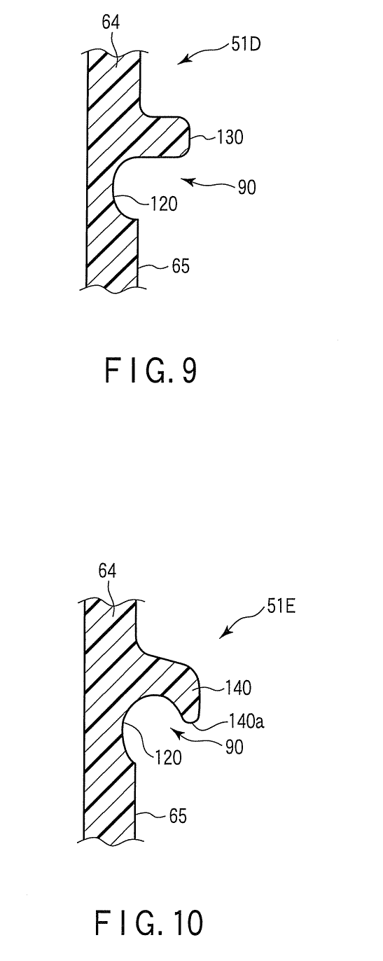

FIG. 9 is a sectional view of a part of an inkjet recording head 51D according to a fifth embodiment. In the inkjet recording head 51D, the groove 120 and the ridge 130 are formed on the peripheral surface 65 of the first cover member 64 as the ink regulating section 90. The ridge 130 is formed on the upper side of the groove 120. In the inkjet recording head 51D, when ink droplets adhering to the surface 61a of the orifice member 61 move upward, the ink droplets enter the groove 120 and the movement of the ink droplets is blocked by the ridge 130. Therefore, the ink droplets are more effectively prevented from reaching the gap G. The other components and actions of the inkjet recording head 51D are the same as those of the inkjet recording head 51 according to the first embodiment. Therefore, the same components are denoted by the same reference numerals and signs and explanation of the components is omitted.

FIG. 10 is a sectional view of a part of an inkjet recording head 51E according to a sixth embodiment. In the inkjet recording head 51E, the groove 120 and a ridge 140 are formed on the peripheral surface 65 of the first cover member 64 as the ink regulating section 90. Moreover, a distal end 140a of the ridge 140 faces downward. Therefore, the upward movement of ink droplets adhering to the surface 61a of the orifice member 61 can be more effectively blocked by the ridge 140. The other components and actions of the inkjet recording head 51E are the same as those of the inkjet recording head 51D according to the fifth embodiment. Therefore, the same components are denoted by the same reference numerals and signs and explanation of the components is omitted.

As explained above, with the inkjet recording heads according to the embodiments, the ink droplets 85 adhering to the orifice member 61 can be prevented from moving to the gap G of the cover structure 76 by the ink regulating section 90. Therefore, even if ink droplets of ink mist caused when the ink is ejected from the ejection holes 70 or ink droplets left unwiped by wiping of head maintenance accumulate on the surface 61a of the orifice member 61 and the end face 66 of the first cover member 64, the ink droplets are prevented from creeping up on a sidewall while wetting the sidewall with the surface tension of the ink. Therefore, it is possible to prevent the ink from intruding into the inside of the cover structure 76 and staining components and a bonding section on the inside. Consequently, it is possible to improve reliability of an inkjet printer including inkjet recording heads arranged along the circumferential surface of a sheet conveying drum.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An inkjet recording head comprising:
an orifice member including an ejection hole which ejects ink;
a first cover member including a peripheral surface, which surrounds an outer peripheral surface of the orifice member, one end face arranged near the orifice member, and an other end and including an ink regulating section formed on the peripheral surface and which suppresses movement of ink; and
a second cover member arranged to extend to the other end of the peripheral surface of the first cover member.

2. The inkjet recording head according to claim 1, wherein the ink regulating section comprises an ink repellent treatment surface.

3. The inkjet recording head according to claim 1, wherein the ink regulating section comprises a groove recessed to an inner side of the peripheral surface of the first cover member.

4. The inkjet recording head according to claim 1, wherein the ink regulating section comprises a ridge projected to an outer side of the peripheral surface of the first cover member.

5. The inkjet recording head according to claim 1, wherein the ink regulating section is continuously formed over an entire periphery of the peripheral surface of the first cover member.

6. The inkjet recording head according to claim 1, wherein the ink regulating section comprises a groove recessed to an inner side of the peripheral surface of the first cover member and a ridge provided above the groove and projected to an outer side of the first cover member.

7. The inkjet recording head according to claim 1, wherein
the first cover member and the second cover member form a cover structure, and
a gap is present between the other end of the first cover member and the second cover member.

8. An inkjet printer comprising:
a sheet conveying mechanism including a sheet conveying drum which rotates on an inside of a housing in a state in which a sheet is held on the sheet conveying drum;
an inkjet recording head including: an orifice member including an ejection hole which ejects ink; a first cover member including a peripheral surface, which surrounds an outer peripheral surface of the orifice member, one end face arranged near the orifice member, and an other end and including an ink regulating section formed on the peripheral surface and suppresses movement of ink; and a second cover member arranged to extend to the other end of the peripheral surface of the first cover member, the inkjet recording head ejecting the ink to the sheet; and
a discharge mechanism which takes out the sheet, on which an image is formed by the ejection of the ink, from the sheet conveying drum.

9. The inkjet printer according to claim 8, wherein the orifice member of the inkjet recording head is arranged in a posture opposed to a circumferential surface of the sheet conveying drum and tilted with respect to a horizontal plane.

10. The inkjet printer according to claim 9, wherein the ink regulating section is continuously formed over an entire periphery of the peripheral surface of the first cover member.

11. The inkjet printer according to claim 9, wherein the ink regulating section is formed on a surface lower with respect to the horizontal plane in the peripheral surface of the first cover member.

12. The inkjet printer according to claim 9, wherein the ink regulating section comprises an ink repellent treatment surface.

13. The inkjet printer according to claim 9, wherein the ink regulating section comprises a groove recessed to an inner side of the peripheral surface of the first cover member.

14. The inkjet printer according to claim 9, wherein the ink regulating section comprises a ridge projected to an outer side of the peripheral surface of the first cover member.

15. The inkjet printer according to claim 9, further comprising a head maintenance mechanism for removing ink adhering to the first cover member.

16. An inkjet recording method comprising:
conveying a sheet to a sheet conveying drum;
rotating the sheet conveying drum in a state in which the sheet is held on the sheet conveying drum;
ejecting ink to the sheet from an inkjet recording head including: an orifice member including an ejection hole which ejects ink; a first cover member including a peripheral surface, which surrounds an outer peripheral surface of the orifice member, one end face arranged near the orifice member, and an other end and including an ink regulating section formed on the peripheral surface and which suppresses movement of ink; and a second cover member arranged to extend to the other end of the peripheral surface of the first cover member; and
taking out the sheet, on which an image is formed by the ejection of the ink, from the sheet conveying drum.

17. The inkjet recording method according to claim 16, further comprising cleaning the ink adhering to the cover member.

18. The inkjet recording method according to claim 16, wherein the orifice member of the inkjet recording head ejects the ink in a posture opposed to the peripheral surface of the sheet conveying drum and tilted with respect to a horizontal plane.
